(19) United States
(12) Patent Application Publication
(10) Pub. No.: US 2026/0073612 A1
(43) Pub. Date: Mar. 12, 2026

(54) VIRTUAL PRODUCTION PLANNING SYSTEM

(71) Applicants: Sony Group Corporation, Tokyo (JP); Sony Pictures Entertainment Inc., Culver City, CA (US)

(72) Inventors: Jason Elbourne, Belleville (CA); Mahmoud Rahnama, Toronto (CA); Gatis Kurzemnieks, Etterbeek (BE)

(21) Appl. No.: 18/830,405

(22) Filed: Sep. 10, 2024

(51) Int. Cl. G06T 15/00; G06F 3/14; G06Q 10/02; G06Q 30/0283

(52) U.S. Cl. CPC G06T 15/005; G06F 3/1446; G06Q 10/02; G06Q 30/0283

(57) ABSTRACT

Planning virtual production from a digital application, including: performing digital planning and management of the virtual production to produce at least video output of a digital LED wall from a virtual camera mimicking filming on a virtual LED wall of the virtual production including: rendering pre-visualization of the virtual production; and generating technical visualization of the virtual production within a virtual environment; automatically generating a cost estimate of the virtual production based on the rendered pre-visualization and the generated technical visualization of the virtual production; and enabling requests for booking a sound stage from the digital application when the cost estimate is acceptable.

### BACKGROUND

### Field

The present disclosure relates to virtual production planning, and more specifically, to a virtual production planning system including a digital management of the LED virtual production sound stage with optional motion control equipment.

### Background

Traditional virtual production involves filming actors in front of a green screen and adding the background and visual effects to the scene in post-production. With LED walls, the background is displayed behind the actors and physical set to allow the director/staff to see the scene in real-time. Thus, the virtual production LED setup may include equipment, systems and software with user interfaces and application programming interfaces (APIs).

FIG. 1 is a flow diagram illustrating one example of a traditional LED virtual production management process 100. Initially, a shot list is generated, at step 110, using a spreadsheet or handwritten list. Storyboards are then created, at step 120, to communicate production goals. A pre-visualization is rendered, at step 130, using a 3-D digital content creation (DCC) software package such as Maya or Blender. A technical visualization is determined, at step 140, using the 3-D DCC software package. A price is calculated, at step 150, using day rate and production estimator experience. Finally, the sound stage is booked, at step 160, through a sound stage manager directly.

Therefore, the current LED virtual production management may involve complex and extensive production logistics including designing, planning, organizing, and generating shot lists, visualizations, costs, and timelines associated with the virtual production. Often these project phases must be completed by different departments or companies. Accordingly, a need exists for improved planning and management of the LED virtual production sound stage projects.

### SUMMARY

The present disclosure implements techniques for virtual production planning.

In one implementation, a computer-implemented method of planning virtual production from a digital application is disclosed. The method includes: performing digital planning and management of the virtual production to produce at least video output of a digital LED wall from a virtual camera mimicking filming on a virtual LED wall of the virtual production including: rendering pre-visualization of the virtual production; and generating technical visualization of the virtual production within a virtual environment; automatically generating a cost estimate of the virtual production based on the rendered pre-visualization and the generated technical visualization of the virtual production; and automatically estimating the cost of LED sound stage booking from the digital application and enabling requests for booking a sound stage.

In another implementation, a system for planning a virtual production is disclosed. The system includes: a client plane configured as application programming interface (API) gateways including a web client and a network gate, wherein the client plane performs digital management of data related to filming on a virtual LED wall of the virtual production including project meta data, booking requests, quote estimates and formal project quotes; a control plane configured as a service mesh including an API proxy server to provide service registry, permissions, load balance, analytics, and cache functions; and a data plane including servers and databases for user profile microservice, bookings microservice, quotes microservice, locations microservices, and client microservice.

Other features and advantages should be apparent from the present description which illustrates, by way of example, aspects of the disclosure.

### BRIEF DESCRIPTION OF THE DRAWINGS

The details of the present disclosure, both as to its structure and operation, may be gleaned in part by study of the appended drawings, in which like reference numerals refer to like parts, and in which:

FIG. 1 is a flow diagram illustrating one example of a traditional LED virtual production management process;

FIG. 2A is a flow diagram of a process of the digital twin application running on the virtual production planning system in accordance with one implementation of the present disclosure;

FIG. 2B is a block diagram of the virtual production planning system in accordance with one implementation of the present disclosure;

FIG. 3A is a representation of a computer system and a user in accordance with an implementation of the present disclosure; and

FIG. 3B is a functional block diagram illustrating the computer system hosting the digital twin application in accordance with an implementation of the present disclosure.

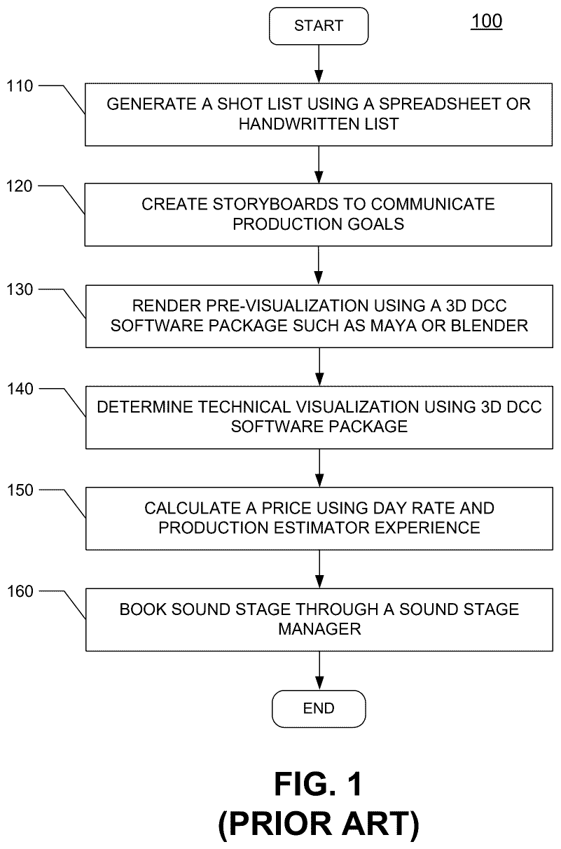

### DETAILED DESCRIPTION

As described above, a need exists for improved planning and management of an LED virtual production sound stage project.

Certain implementations of the present disclosure provide for a virtual production planning system including a digital planning and management of the LED virtual production sound stage. After reading the below descriptions, it will become apparent how to implement the disclosure in various implementations and applications. Although various implementations of the present disclosure will be described herein, it is understood that these implementations are presented by way of example only, and not limitation. As such, the detailed description of various implementations should not be construed to limit the scope or breadth of the present disclosure.

In one implementation, the digital planning and management of the LED virtual production sound stage is performed using a digital twin application which enables a user to design, plan and organize productions shot by shot and visualize logistics, costs and timelines associated with a virtual production. The user may then produce video output from a virtual camera mimicking the filming on an LED virtual production wall, which utilizes the same virtual art on the digital twin virtual LED wall that will be used on the actual production LED wall during principal photography. The digital twin application also enables the user to organize and customized the production shots by setting up a stage, camera, and virtual environment, along with optional practical vehicle and optional motion platform. Once the production shots are planned, the user may then output the camera view as rendered image sequences. The user may also view an estimated cost of the sound stage usage and book time(s) needed directly from the digital twin application. Thus, in one implementation, data used by the digital twin application includes project meta data, booking requests, quote estimates and formal project quotes.

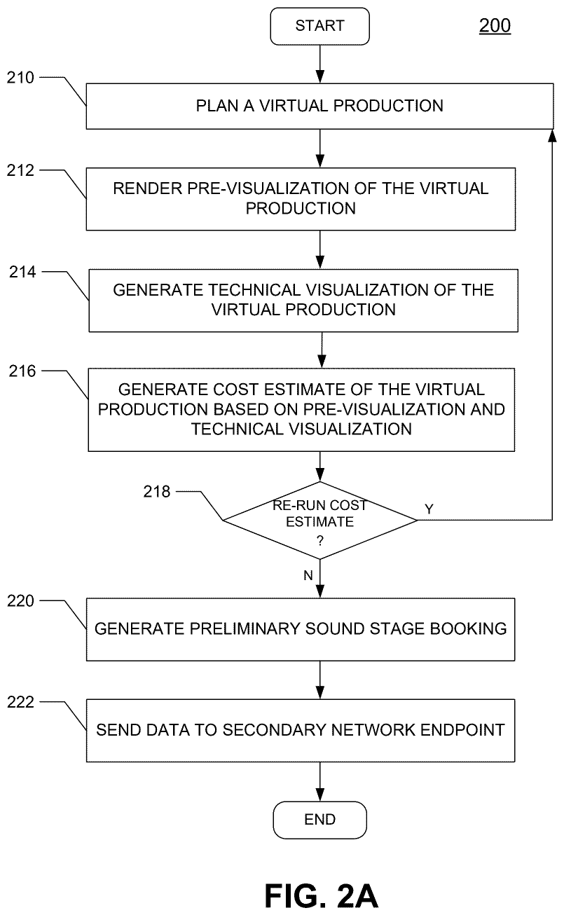

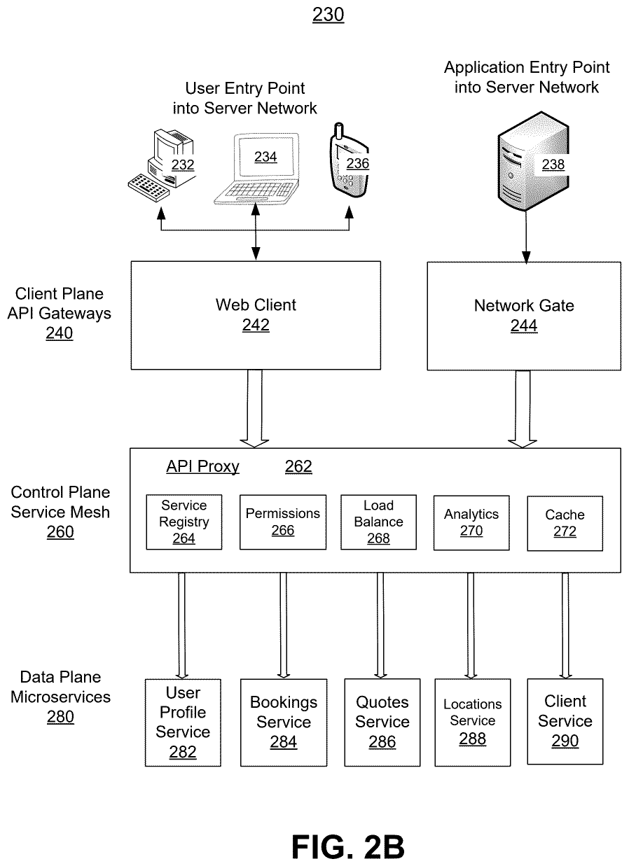

FIG. 2A is a flow diagram of a computer-implemented process 200 of the digital twin application running on the virtual production planning system in accordance with one implementation of the present disclosure. In the illustrated implementation of FIG. 2A, a virtual production is planned, at step 210. In one implementation, the planning step 210 includes: (a) making decisions on which sound stage location to use for the virtual production; (b) pre-planning the production to fit a budget; (c) pre-booking a sound stage production day(s) (estimate of setup, production and teardown days) based on the availability of the sound stage; and (d) synchronizing environments and vehicle assets from an embedded library or external library source.

In the illustrated implementation of FIG. 2A, the planning step 210 may also include rendering of pre-visualization of the virtual production, at step 212. In one implementation, the rendering of the pre-visualization step 212 includes: (a) previewing a virtual environment on a digital LED wall to match the virtual LED wall for the production; (b) creating camera setups and adding scenes to setups; (c) changing environments on a per scene basis; (d) changing vehicles on a per scene basis; (e) changing lighting on a per scene basis; (f) making changes to the virtual environment in real time using a custom user interface, such as but not limited to weather, seasons, traffic, animals, lighting, and time of day; (g) making changes to the driving characteristics of a vehicle in the virtual environment; (h) managing multiple driving scenarios to mimic multiple-vehicle-action scenes; and (i) adding light cards to the digital LED wall to match how the virtual LED wall uses the light cards during principal photography.

In the illustrated implementation of FIG. 2A, the planning step 210 may further include generating a technical visualization, at step 214. In one implementation, the generation of the technical visualization step 214 includes: (a) dynamically determining vehicle motions as it traverses a path within the virtual environment and transferring the motions to a virtual vehicle motion control platform; (b) enabling to control the vehicles in the virtual environment from external controllers such as a driving simulator; (c) dynamically determining the position of a virtual camera connected to a crane to achieve a production-in-camera look; (d) dynamically generating other camera setups (other than crane platform) to achieve various looks; (e) dynamically generating lighting setups in the virtual space and visualizing the effects on the shot through a camera; and (f) previewing through various types and position of the cameras to determine whether the production shot can be displayed on the LED wall or would require visual effects work in post-production.

In the illustrated implementation of FIG. 2A, a cost estimate of the virtual production is generated, at step 216, based on the tasks performed in steps 210, 212, 214. In one implementation, the generation of the cost estimate step 216 includes: (a) reviewing preliminary estimate directly from the digital twin application, which is dynamically calculated by the camera setups and shots designed by the user within a project; (b) viewing a breakdown of costs used to calculate the estimate for a project; (c) submitting a formal request to the sound stage manager to confirm soundstage booking and costs; (d) reviewing the previously requested estimates and confirmed quotes for booking a sound stage for a project; and (e) cancelling previously requested estimates for booking sound stages for a project.

In the illustrated implementation of FIG. 2A, a determination is made, at step 218, whether to re-run the cost estimate for various reasons. If it is determined, at step 218, that the cost estimate is to be re-run, some or all of steps 210, 212, 214, 216 are performed again. Otherwise, if it is determined, at step 218, that the cost estimate is not to be re-run, the process 200 moves to step 220.

In the illustrated implementation of FIG. 2A, a preliminary sound stage booking is generated, at step 220. In one implementation, the generation of the preliminary sound stage booking step 220 includes: (a) reviewing preliminary booking directly from the digital twin application; (b) submitting a formal request to the sound stage manager to confirm soundstage booking; (c) reviewing previously requested bookings and confirming booked sound stages for a project; and (d) cancelling previously requested booking of the sound stages for a project.

In the illustrated implementation of FIG. 2A, the data generated by steps 210, 212, 214, 216 is transmitted, at step 222, to a secondary network endpoint. In one implementation, data is transmitted directly from the digital twin application to the secondary network endpoint. In one implementation, the transmission of data step 222 includes transmitting: (a) virtual camera location and rotation data; (b) current virtual vehicle location in environment as data; and (c) virtual environment properties configured by the user of the application as data. In one implementation, the secondary network location includes a secondary network endpoint including a network gate of a client plane application programming interface (API) gateway.

In one implementation, all blocks in FIG. 2A are configured entirely with hardware including one or more digital signal processors (DSPs), general purpose microprocessors, application specific integrated circuits (ASICs), field programmable logic arrays (FPGAs), or other equivalent integrated or discrete logic circuitry. One implementation includes one or more programmable processors and corresponding computer system components to store and execute computer instructions, such as to provide the operation of a wallet infrastructure at the user level and provider level (provider of products, assets, content, etc.).

As described above, the virtual production planning system involves digital management of the LED virtual production sound stage performed to produce at least video output from a virtual camera mimicking the filming on an LED virtual production wall. In one implementation, the virtual production planning system includes: (a) standalone desktop applications running on personal computers of users; (b) a server for desktop application distribution to end users; (c) a server for client plane application programming interface (API) gateway; (d) a server for control plane API proxy; and (e) servers and databases for bookings microservice, locations microservice, clients microservice, quotes microservice, and user profile microservice.

FIG. 2B is a block diagram of the virtual production planning system 230 in accordance with one implementation of the present disclosure. In the illustrated implementation of FIG. 2B, the virtual production planning system 230 is divided into a client plane 240, a control plane 260, and a data plane 280.

In the illustrated implementation of FIG. 2B, the client plane 240 is API gateways including a web client 242 and a network gate 244. In one implementation, the web client 242 provides a user entry point into the system 230 using one of desktop 232, laptop 234, or mobile phone 236. The web client 242 provides a human user an entry point into the platform system for bookings and quotes through a web portal. In one implementation, the network gate 244 provides a software application entry point into the system 230 using a standalone computer 238. The network gate 244 is a server for the client plane API gateway allowing authorization to connect by verifying API keys and license user license files.

In the illustrated implementation of FIG. 2B, the control plane 260 is a service mesh including an API proxy server 262. In one implementation, the API proxy server 262 provides microservice registry 264, permissions 266, load balancing 268, analytics 270, and cache 272.

In the illustrated implementation of FIG. 2B, the data plane 280 includes servers and databases for user profile microservice 282, bookings microservice 284, quotes microservice 286, locations microservices 288, and client microservice 290. Thus, the proxy server 262 connects to one of these microservices 282-290 for performing each of the noted platform requests.

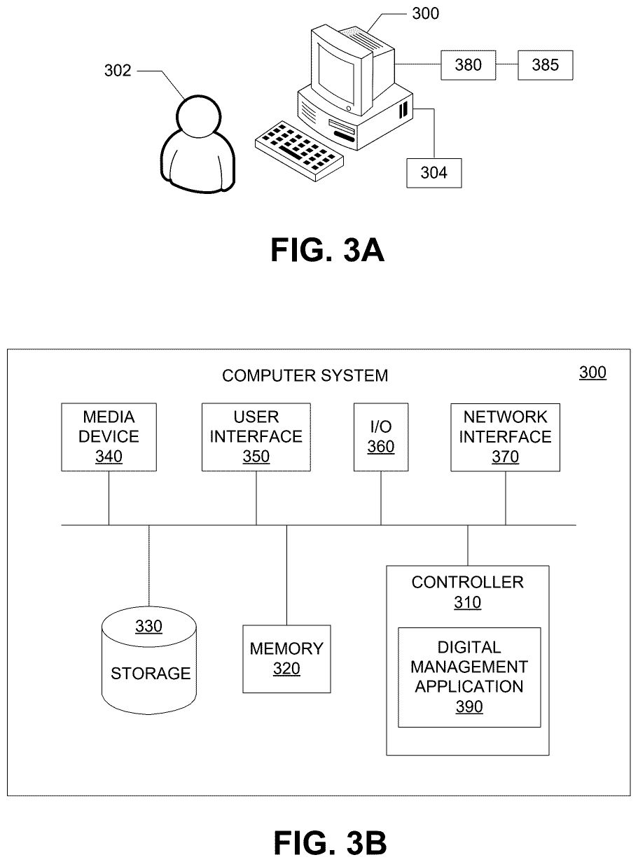

FIG. 3A is a representation of a computer system 300 and a user 302 in accordance with an implementation of the present disclosure. The user 302 uses the computer system 300 to implement the digital twin application 390 of the LED virtual production for the virtual production planning system with respect to the process 200 of FIG. 2A.

The computer system 300 stores and executes the digital twin application 390 of FIG. 3B. In addition, the computer system 300 may be in communication with a software program 304. Software program 304 may include the software code for the digital twin application 390. Software program 304 may be loaded on an external medium such as a CD, DVD, tape or any other storage drive, as will be explained further below.

Furthermore, the computer system 300 may be connected to a network 380. The network 380 can be connected in various different architectures, for example, client-server architecture, a Peer-to-Peer network architecture, or other type of architectures. For example, network 380 can be in communication with a server 385 that coordinates engines and data used within the digital twin application 390. Also, the network can be different types of networks. For example, the network 380 can be the Internet, a Local Area Network or any variations of Local Area Network, a Wide Area Network, a Metropolitan Area Network, an Intranet or Extranet, or a wireless network.

FIG. 3B is a functional block diagram illustrating the computer system 300 hosting the digital twin application 390 in accordance with an implementation of the present disclosure. A controller 310 is a programmable processor and controls the operation of the computer system 300 and its components. The controller 310 loads instructions (e.g., in the form of a computer program) from the memory 320 or an embedded controller memory (not shown) and executes these instructions to control the system, such as to provide the data processing. In its execution, the controller 310 provides the digital twin application 390 with a software system. Alternatively, this service can be implemented as separate hardware components in the controller 310 or the computer system 300.

Memory 320 stores data temporarily for use by the other components of the computer system 300. In one implementation, memory 320 is implemented as RAM. In one implementation, memory 320 also includes long-term or permanent memory, such as flash memory and/or ROM.

Storage 330 stores data either temporarily or for long periods of time for use by the other components of the computer system 300. For example, storage 330 stores data used by the digital twin application 390. In one implementation, storage 330 is a hard disk drive.

The media device 340 receives removable media and reads and/or writes data to the inserted media. In one implementation, for example, the media device 340 is an optical disc drive.

The user interface 350 includes components for accepting user input from the user of the computer system 300 and presenting information to the user 302. In one implementation, the user interface 350 includes a keyboard, a mouse, audio speakers, and a display. In another implementation, the user interface 350 also includes a headset worn by the user and used to collect eye movements as user inputs. The controller 310 uses input from the user 302 to adjust the operation of the computer system 300.

The I/O interface 360 includes one or more I/O ports to connect to corresponding I/O devices, such as external storage or supplemental devices (e.g., a printer or a PDA). In one implementation, the ports of the I/O interface 360 include ports such as: USB ports, PCMCIA ports, serial ports, and/or parallel ports. In another implementation, the I/O interface 360 includes a wireless interface for communication with external devices wirelessly.

The network interface 370 includes a wired and/or wireless network connection, such as an RJ-45 or “Wi-Fi” interface (including, but not limited to 802.11) supporting an Ethernet connection.

The computer system 300 includes additional hardware and software typical of computer systems (e.g., power, cooling, operating system), though these components are not specifically shown in FIG. 3B for simplicity. In other implementations, different configurations of the computer system can be used (e.g., different bus or storage configurations or a multi-processor configuration).

In alternative implementations, following variations may be implemented: (a) the digital twin application may be built using the game engine framework Unreal Engine, Unity, Godot, or other similar game engines; (b) vehicle control in the virtual world may have input from an existing game controller or a driving simulation steering wheel; (c) a user may request and/or adjust the booking from a Web user interface (UI) rather than the digital twin desktop application; (d) a user may request and/or adjust the quote from the Web UI rather than the digital twin application; and (e) the data may be exported or transmitted for the motion platform with individual hydraulic actuator (leg) length/properties versus only the xyz-UVW values.

In summary, the new features of the virtual production planning system in accordance with the present disclosure include: (a) cataloging of digital LED wall setups in sound stages around the globe for use in one application; (b) simulating two 3-D virtual worlds concurrently in which one world may dynamically affect the other world in real-time; (c) providing real-time playback of virtual environment to enable the dynamic vehicle physics/motion data to control the virtual vehicle motion platform in another 3-D virtual world; (d) transmitting the dynamically generated movement data as xyz-UVW data from the virtual vehicle motion platform to a physical vehicle motion platform; (e) dynamically adjusting costs for booking an LED soundstage globally using the digital twin application; (f) enabling a user to book a sound stage from a global collection of sound stages with dynamic stage availability within the digital twin application.

The advantages of the virtual production planning system in accordance with the present disclosure include efficiency provided by: (a) combining all aspects of planning a production into a single visually accurate digital twin application; (b) enabling the user to book a sound stage across the globe and to review the availability of the selected sound stage location in real-time; (c) enabling generation and organization of shot lists more accurately with visual representation; (d) rendering all pre-visualizations from a single application (versus using different applications) for planning, estimates, pre-visualization and technical visualization; (e) making a choice within the digital twin application enables automatic adjustment of cost estimates; (f) making a choice within the digital twin application enables verification whether a sound stage availability works for the plan; (g) planning and managing multiple projects which are all stored within a single application for management and organization; and (h) managing and tracking bookings approvals and project quotes directly from within the digital twin application.

In a particular implementation, a computer-implemented method of planning virtual production from a digital application is disclosed. The method includes: performing digital management of the virtual production to produce at least video output of a digital LED wall from a virtual camera mimicking filming on a virtual LED wall of the virtual production including: rendering pre-visualization of the virtual production; and generating technical visualization of the virtual production within a virtual environment; automatically generating a cost estimate of the virtual production based on the rendered pre-visualization and the generated technical visualization of the virtual production; and enabling requests for booking a sound stage from the digital application when the cost estimate is acceptable.

In one implementation, rendering the pre-visualization includes previewing the virtual environment on the digital LED wall to match the LED wall on the soundstage represented virtually for the virtual production. In one implementation, rendering the pre-visualization includes creating camera setups and adding scenes to the camera setups. In one implementation, rendering the pre-visualization includes changing at least one of environments, vehicles, and lighting on a per scene basis. In one implementation, rendering the pre-visualization includes making changes to the virtual environment in real-time using a custom user interface including at least one of weather, seasons, traffic, animals, lighting, and time of day. In one implementation, rendering the pre-visualization includes making changes to driving characteristics of a vehicle in the virtual environment. In one implementation, rendering the pre-visualization includes adding light cards to the digital LED wall to match how the virtual LED wall uses light cards. In one implementation, generating the technical visualization includes dynamically determining motions of a vehicle as it traverses a path within the virtual environment and transferring the motions to a virtual vehicle motion control platform. In one implementation, generating the technical visualization includes enabling to control the vehicle in the virtual environment from external controllers including a driving simulator. In one implementation, generating the technical visualization includes dynamically determining a position of the virtual camera to achieve a production-in-camera look. In one implementation, generating the technical visualization includes dynamically generating lighting setups in the virtual environment and visualizing effects on a shot through the virtual camera. In one implementation, generating the technical visualization includes previewing through the virtual camera to determine whether the shot can be displayed on the LED wall or require visual effects work in post-production. In one implementation, generating the cost estimate of the virtual production includes reviewing a preliminary estimate directly from the digital application, wherein the preliminary estimate is dynamically calculated by the camera setups and shots designed by a user within a project. In one implementation, generating the cost estimate of the virtual production includes submitting a formal request to a sound stage manager to confirm soundstage booking and costs. In one implementation, the method further includes transmitting virtual camera location and rotation data. In one implementation, the method further includes transmitting current virtual vehicle location. In one implementation, the method further includes transmitting virtual environment properties configured by a user of the digital application.

In another particular implementation, a system for planning a virtual production is disclosed. The system includes: a client plane configured as application programming interface (API) gateways including a web client and a network gate, wherein the client plane performs digital management of data related to filming on a virtual LED wall of the virtual production including project meta data, booking requests, quote estimates and formal project quotes; a control plane configured as a service mesh including an API proxy server to provide service registry, permissions, load balance, analytics, and cache functions; and a data plane including servers and databases for user profile microservice, bookings microservice, quotes microservice, locations microservices, and client microservice.

In one implementation, the web client provides a user entry point into the system using one of desktop, laptop, or mobile phone. In one implementation, the network gate provides a software application entry point into the system using a standalone computer.

All features of each of the above-discussed examples are not necessarily required in a particular implementation of the present disclosure. Further, it is to be understood that the description and drawings presented herein are representative of the subject matter which is broadly contemplated by the present disclosure. It is further understood that the scope of the present disclosure fully encompasses other implementations that may become obvious to those skilled in the art and that the scope of the present disclosure is accordingly limited by nothing other than the appended claims.

1. A computer-implemented method of planning virtual production from a digital application, the method comprising:
performing digital planning and management of the virtual production to produce at least video output of a digital LED wall from a virtual camera mimicking filming on a virtual LED wall of the virtual production including:
rendering pre-visualization of the virtual production; and generating technical visualization of the virtual production within a virtual environment;
automatically generating a cost estimate of the virtual production based on the rendered pre-visualization and the generated technical visualization of the virtual production; and
enabling requests for booking a sound stage from the digital application when the cost estimate is acceptable.

2. The method of claim 1, wherein rendering the pre-visualization comprises
previewing the virtual environment on the digital LED wall to match the LED wall on the soundstage represented virtually for the virtual production.

3. The method of claim 1, wherein rendering the pre-visualization comprises
creating camera setups and adding scenes to the camera setups.

4. The method of claim 1, wherein rendering the pre-visualization comprises
changing at least one of environments, vehicles, and lighting on a per scene basis.

5. The method of claim 1, wherein rendering the pre-visualization comprises
making changes to the virtual environment in real-time using a custom user interface including at least one of weather, seasons, traffic, animals, lighting, and time of day.

6. The method of claim 1, wherein rendering the pre-visualization comprises
making changes to driving characteristics of a vehicle in the virtual environment.

7. The method of claim 1, wherein rendering the pre-visualization comprises
adding light cards to the digital LED wall to match how the virtual LED wall uses light cards.

8. The method of claim 1, wherein generating the technical visualization comprises
dynamically determining motions of a vehicle as it traverses a path within the virtual environment and transferring the motions to a virtual vehicle motion control platform.

9. The method of claim 8, wherein generating the technical visualization comprises
enabling to control the vehicle in the virtual environment from external controllers including a driving simulator.

10. The method of claim 1, wherein generating the technical visualization comprises
dynamically determining a position of the virtual camera to achieve a production-in-camera look.

11. The method of claim 1, wherein generating the technical visualization comprises
dynamically generating lighting setups in the virtual environment and visualizing effects on a shot through the virtual camera.

12. The method of claim 11, wherein generating the technical visualization comprises
previewing through the virtual camera to determine whether the shot can be displayed on the LED wall or require visual effects work in post-production.

13. The method of claim 1, wherein generating the cost estimate of the virtual production comprises
reviewing a preliminary estimate directly from the digital application,
wherein the preliminary estimate is dynamically calculated by the camera setups and shots designed by a user within a project.

14. The method of claim 1, wherein generating the cost estimate of the virtual production comprises
submitting a formal request to a sound stage manager to confirm soundstage booking and costs.

15. The method of claim 1, further comprising
transmitting virtual camera location and rotation data.

16. The method of claim 1, further comprising
transmitting current virtual vehicle location.

17. The method of claim 1, further comprising
transmitting virtual environment properties configured by a user of the digital application.

18. A system for planning a virtual production, the system comprising:
a client plane configured as application programming interface (API) gateways including a web client and a network gate,
wherein the client plane performs digital management of data related to filming on a virtual LED wall of the virtual production including project meta data, booking requests, quote estimates and formal project quotes;
a control plane configured as a service mesh including an API proxy server to provide service registry, permissions, load balance, analytics, and cache functions; and
a data plane including servers and databases for user profile microservice, bookings microservice, quotes microservice, locations microservices, and client microservice.

19. The system of claim 18, wherein the web client provides a user entry point into the system using one of desktop, laptop, or mobile phone.

20. The system of claim 18, wherein the network gate provides a software application entry point into the system using a standalone computer.
